(19) United States
(12) Patent Application Publication
(10) Pub. No.: US 2013/0180627 A1
(43) Pub. Date: Jul. 18, 2013

(54) COMPOSITE MATERIAL FOR DENTAL PROSTHESIS AND METHOD FOR MANUFACTURING THE SAME

(71) Applicants: Eri MIURA, Nagoya (JP); Soichiro YAMADA, Iwakura (JP); Yoshimi WATANABE, Tokyo (JP); Hisashi SATO, Kuwana (JP); Toshihiro KASUGA, Kiyosu (JP); Mitsuo NIINOMI, Sendai (JP)

(72) Inventors: Eri MIURA, Nagoya (JP); Soichiro YAMADA, Iwakura (JP); Yoshimi WATANABE, Tokyo (JP); Hisashi SATO, Kuwana (JP); Toshihiro KASUGA, Kiyosu (JP); Mitsuo NIINOMI, Sendai (JP)

(73) Assignee: NAGOYA INSTITUTE OF TECHNOLOGY, Nagoya (JP)

(21) Appl. No.: 13/602,995

(22) Filed: Sep. 4, 2012

(30) Foreign Application Priority Data
Jan. 18, 2012 (JP) 2012-007589

(51) Int. Cl. C23C 8/10; B32B 15/04; C22F 1/18

(52) U.S. Cl. 148/284; 148/421

(57) ABSTRACT

Disclosed is a metal-metal oxide composite material for dental prosthesis, which has a white surface with good aesthetic quality and includes a titanium or titanium alloy substrate; and an oxidation layer present on a surface of the substrate. The metal-metal oxide composite material is manufactured by subjecting the substrate to a heat treatment at a temperature of around 1000° C. in an oxygen-containing atmosphere to form the oxidation layer on the surface of the substrate with good adhesion.

### FIELD OF THE INVENTION

The present invention relates to a technique for whitely coating a surface of a Ti-Nb-Ta-Zr alloy or commercially pure titanium substrate. The resulting material is usable particularly as dental materials.

### RELATED ART OF THE INVENTION

With recent growing interests on improvements in quality of life (QOL) and safety, “white metals” have been demanded typically as dental materials, because such white metals have satisfactory toughness and strengths, are highly aesthetic, and are suitable as alternative materials to hard tissues. The white metals should have two roughly-categorized properties. One category includes mechanical properties necessary and sufficient as hard tissues, particularly as prostheses for bone and teeth; and the other includes satisfactory aesthetic quality as dental prostheses. In addition, the white metals should naturally be safe and compatible to living bodies and be capable of replacing a body composition or of long-term indwelling in living bodies. Though there is no material satisfying all the requirements at present, metals are most superior as alternative materials to hard tissues, except for their aesthetic quality.

FIG. 1 is a schematic view of a metal bonding porcelain crown as a technique for producing a customary artificial tooth. This artificial tooth is generally prepared by building-up a metal frame on a tooth core, and sequentially building-up opaque, dentin, and enamel porcelains thereon to mask the metal color. A resin-facing metal crown using a resin instead of porcelains has a basically similar structure as above. Natural teeth generally have a lightness L* of 60 to 80 as described by Hasegawa et al. in Non Patent Literature 1 (Akira Hasegawa, Akio Motonomi, Ikuo Ikeda, Satoshi Kawaguchi , Color Research & Application, 2000, vol.25 (1) , pp. 43-48) ; whereas the opaque resin for covering the metal tooth core has a lightness L* of at largest about 80 as described by Shiba et al. in Non Patent Literature 2 (Cho Shiba, Mitsunori Uno, Gen Ishigami, Masakazu Kurachi , J. Gifu Dent. Soc., 2009, vol. 35, (3) , pp. 149-159) . However, such techniques for covering a metal tooth core with a porcelain or resin disadvantageously suffer from peeling or delamination between the tooth core and the coating material.

Titanium alloys, when used as dental materials, have insufficient aesthetic quality because of luster inherent to such metals and should be whitened for resembling natural teeth. Exemplary techniques for whitening include a technique for whitening by coating a Gum Metal (registered trademark) with a nitride or carbide through physical vapor deposition, as disclosed in Japanese Unexamined Patent Application Publication (JP-A) No. 2008-086633. Independently, a technique of coating an orthodontic wire with a silver (Ag) film and a polymer compound film is disclosed in PCT International Publication Number WO2007/075003A1. The technique disclosed in JP-A No. 2008-086633 requires special facilities for the physical vapor deposition process. The technique disclosed in WO2007/075003A1 does not relate to whitening. Independently, exemplary techniques for surface oxidation of titanium include anodization for bone growth enhancement and for better abrasion resistance; and a technique relating to colored titanium materials for artistic purposes. However, these techniques relating to anodization and colored titanium materials do not relate to whitening of material surface. In addition, such techniques of coating a material as a substrate with a coating of another material of a different kind may always be in danger of peeling between the substrate and the coating.

### SUMMARY OF THE INVENTION

An object of the present invention is to provide a dental prosthetic material including titanium or a titanium alloy as a substrate and to improve the aesthetic quality of the substrate while maintaining the strengths and toughness thereof, by forming a white metal oxidation layer (hereinafter also referred to as an “oxidation layer”) on a surface of the titanium or titanium alloy substrate. Such titanium or titanium alloy is employed because of having superior toughness and strengths and having satisfactory biocompatibility and corrosion resistance.

After intensive investigations on a technique for imparting aesthetic quality to titanium or a titanium alloy, the present inventors have found that this is achieved by forming a dense and highly white oxidation layer on the titanium or titanium alloy through a simple heat treatment at a high temperature. The present invention has been made based on these findings.

The present invention provides a composite material for dental prosthesis and a manufacturing method thereof as mentioned below.

[1] The present invention provides, in an aspect, a metal-metal oxide composite material for dental prosthesis, including a metallic substrate including titanium or a titanium alloy; and a metal oxidation layer present on a surface of the substrate, which the metal oxidation layer is an oxide of the substrate metal.

[2] In the metal-metal oxide composite material of [1], the titanium alloy preferably contains 30 to 70 percent by mass of titanium (Ti); 20 to 50 percent by mass of niobium (Nb); 1 to 30 percent by mass of tantalum (Ta); and 1 to 15 percent by mass of zirconium (Zr) . [3] The metal-metal oxide composite material of [1] may be used as a crown material.

[4] In the metal-metal oxide composite material of [1] , the metal oxidation layer may have a thickness of 10 μm or more, and a ratio of the thickness of the metal oxidation layer to the total thickness of the metallic substrate and the metal oxidation layer may be 30% or less.

[5] The present invention further provides, in another aspect, a method for manufacturing the metal-metal oxide composite material of [1] , which method includes the step of performing a heat treatment of titanium or a titanium alloy as a substrate at a high temperature to oxidize a surface of the substrate to thereby form a coating with a high whiteness on the substrate.

[6] In the method of [5] , the heat treatment of the titanium or titanium alloy substrate may be performed at a temperature of 800° C. to 1200° C. in an oxygen-containing atmosphere for a time of 10 minutes to 24 hours.

[7] In the method of [6] , the heat treatment may be performed by holding the substrate to a constant temperature of 950° C. to 1100° C. for a duration time of 10 to 120 minutes. [8] The method of [6] may further include the step of cooling the substrate and the coating at a rate of temperature drop of 2° C./min or less after the heat treatment.

### BRIEF DESCRIPTION OF THE DRAWINGS

Other objects, features and advantages of the present invention will be understood more fully from the following detailed description made with the reference to the accompanying drawings. In the drawings:

FIG. 1 depicts a schematic view of a metal bonding porcelain crown;

FIG. 2 depicts a photograph of a surface of an oxidation layer on a Ti-29Nb-13Ta-4.6Zr alloy substrate as an embodiment of the present invention;

FIG. 3 depicts how the lightness (L*) varies depending on the thickness both of oxidation layers, in which the oxidation layers are an oxidation layer on a Ti-29Nb-13Ta-4.6Zr alloy substrate according to a first embodiment of the present invention (hereinafter also referred to as “First Embodiment”) and an oxidation layer on a commercially pure titanium (hereinafter also simply referred to as “CP Ti ”) substrate according to a third embodiment of the present invention (hereinafter also referred to as “Third Embodiment”);

FIG. 4 depicts how the thickness of oxidation layers varies depending on the duration time (holding time) at a temperature of 1000° C. in a heat treatment, in which the oxidation layers are an oxidation layer on a Ti-29Nb-13Ta-4.6Zr alloy substrate according to First Embodiment and an oxidation layer on a CP Ti substrate according to Third Embodiment;

FIG. 5 depicts a scanning electron photomicrograph (SEM) of a cross section of a Ti-29Nb-13Ta-4.6Zr alloy substrate and an oxidation layer formed on the substrate according to First Embodiment;

FIG. 6 depicts an X-ray diffraction profile of a surface of a Ti-29Nb-13Ta-4.6Zr alloy substrate according to First Embodiment, after a solution treatment;

FIG. 7 depicts an X-ray diffraction profile of an oxidation layer formed on a Ti-29Nb-13Ta-4.6Zr alloy substrate according to First Embodiment, after a heat treatment at a temperature of 1000° C. for a duration time of one hour;

FIG. 8 depicts an X-ray diffraction profile of an oxidation layer formed on a Ti-29Nb-13Ta-4.6Zr alloy substrate according to First Embodiment, after a heat treatment at a temperature of 1000° C. for a duration time of three hours;

FIG. 9 depicts an elemental profile in a depth direction of an oxidation layer of a Ti-29Nb-13Ta-4.6Zr alloy according to First Embodiment, as determined through photoelectron spectroscopy; FIG. 10 depicts how the thickness or lightness (L*) of an oxidation layer varies depending on the duration time in a heat treatment at a temperature of 1025° C., which oxidation layer is formed on a Ti-36Nb-2Ta-3Zr alloy according to a second embodiment of the present invention (hereinafter also referred to as “Second Embodiment”);

FIG. 11 depicts photographs of surfaces of oxidation layers illustrating how whiteness of the oxidation layers varies depending on the temperature and duration time of a heat treatment of a CP Ti substrate according to Third Embodiment;

FIG. 12 depicts an X-ray diffraction profile of a surface of a CP Ti substrate according to Third Embodiment, after a solution treatment;

FIG. 13 depicts an X-ray diffraction profile of an oxidation layer formed on a CP Ti substrate according to Third Embodiment, after a heat treatment at an oxidation temperature of 1000° C. for a duration time of one hour; and

FIG. 14 depicts a transmission electron photomicrograph (TEM) of an oxidation layer of a Ti-29Nb-13Ta-4.6Zr alloy according to First Embodiment.

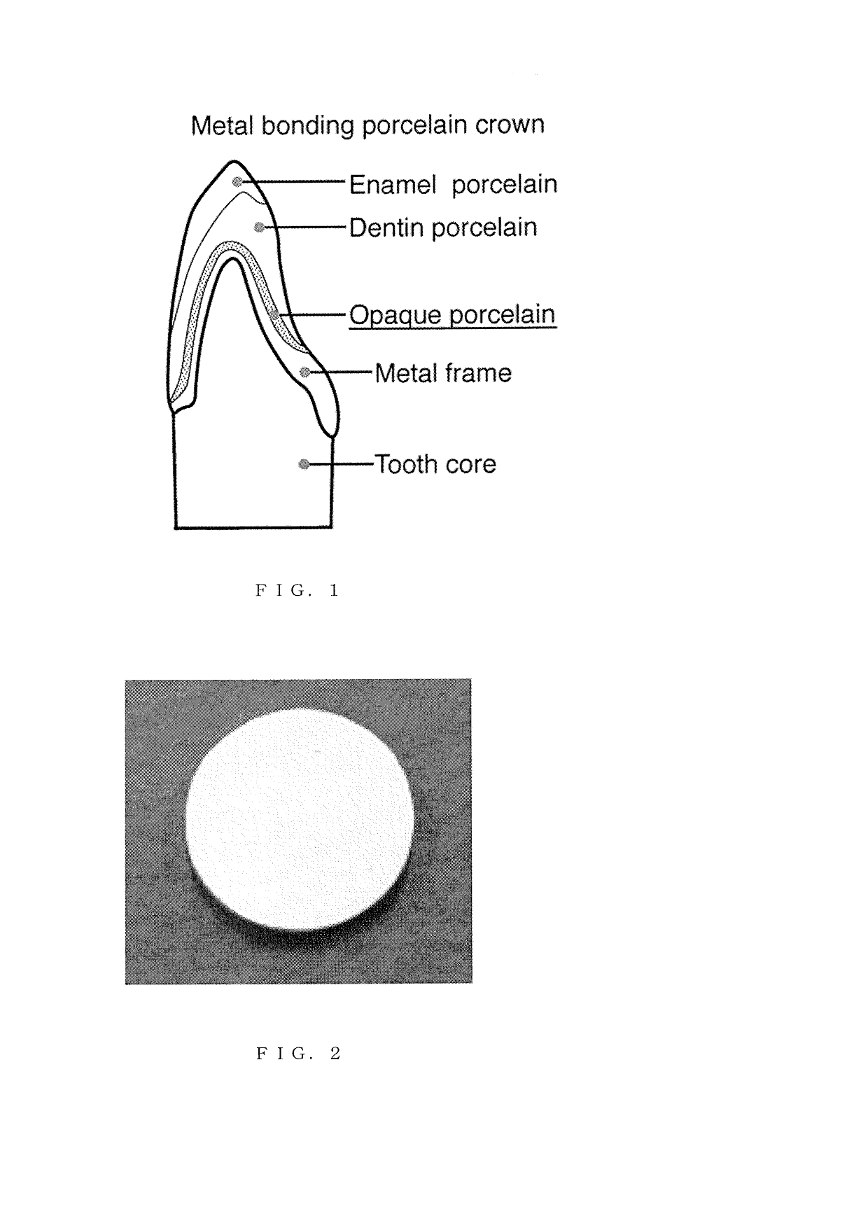

### DETAILED DESCRIPTION OF THE PREFERRED EMBODIMENTS

The present invention will be described further with reference to various embodiments in the drawings.

A substrate for use in the present invention may be a titanium alloy (of which a Ti-Nb-Ta-Zr alloy (hereinafter briefly referred to as “TNTZ”) is preferred) or commercially pure titanium (hereinafter briefly referred to as “CP Ti”). The Ti-Nb-Ta-Zr alloy preferably contains 30 to 70 percent by mass of Ti, 20 to 50 percent by mass of Nb, 1 to 30 percent by mass of Ta, and 1 to 15 percent by mass of Zr, and more preferably contains 40 to 60 percent by mass of Ti, 30 to 50 percent by mass of Nb, 2 to 25 percent by mass of Ta, and 1 to 15 percent by mass of Zr, for satisfactory toughness/strengths, biocompatibility, and whiteness. Exemplary Ti-Nb-Ta-Zr alloys include a Ti-29Nb-13Ta-4.6Zr alloy and a Ti-36Nb-2Ta-3Zr alloy hereinafter illustrated as embodiments, as well as a Ti-34Nb-23Ta-11Zr alloy and a Ti-47Nb-3Ta-4Zr alloy.

Composite materials according to embodiments of the present invention are preferably used as crowns for covering a natural tooth having at least a partial defect (chipping) or as orthodontic members such as brackets to be worn on natural teeth, and arch wires to be attached to brackets. A composite material generally has a U-shaped or T-shaped cross section when used as a crown; has a n-shaped cross section when used as a bracket; and has a linear shape with a round or rectangular cross section when used as an arch wire. Though varying depending on the shape and position of defect (chipped portion) of the natural tooth, the metallic substrate may have a thickness (wall thickness) of 0.1 to 3.0 mm. The wall thickness of the substrate before the heat treatment may be determined or adjusted depending on whether the substrate after the heat treatment is subjected to grinding or not . The oxidation layer may be formed on a bonding face of the substrate to be bonded to a natural tooth, or not. Namely, the presence of the oxidation layer on the bonding face of the substrate does not affect bonding between the natural tooth and the substrate. However, the oxidation layer is preferably formed on a surface including the bonding face with the natural tooth, from the viewpoint of contact with the gum. Absence of an oxidation layer on a part of a substrate surface may be achieved by applying an antioxidant to the part before the heat treatment, or by removing the formed oxidation layer after the heat treatment. The surface (free surface) of the composite material such as crown may be appropriately ground after the heat treatment.

A ratio of the oxidation layer thickness to the total of the substrate wall thickness and the oxidation layer thickness on the substrate is preferably 2% to 30%. As used herein the term “substrate wall thickness” refers to an average thickness of the entire crown. The above range is preferred, because, if the ratio in thickness is more than 30%, the crown may be liable to be deformed as a result of the heat treatment. The thickness of the oxidation layer may be determined based typically on lightness and peel strength (strength against delamination or peeling) of the crown surface, the presence or absence of grinding process after the heat treatment, or abrasion loss of the crown upon use. The oxidation layer has a thickness of preferably 10 to 500 μm, and more preferably 20 to 200 μm. Typically, the peel strength and the lightness L* are generally in a tradeoff relation with each other; and an oxidation layer on CP Ti preferably has a thickness of 40 to 100 μm, and an oxidation layer on a TNTZ preferably has a thickness of 10 to 60 μm. More preferably, an oxidation layer on a Ti-29Nb-13Ta-4.6Zr alloy (TNTZ1) has a thickness of particularly preferably 10 to 60 μm, and an oxidation layer on a Ti-36Nb-2Ta-3Zr alloy (TNTZ2) has a thickness of particularly preferably 20 to 50 μm.

For ensuring such a specific ratio of the oxidation layer thickness to the total wall thickness of the entire crown, the heat treatment of the substrate may be performed in an oxygen-containing atmosphere (e.g., in the air or in an oxygen atmosphere). In this process, the substrate is preferably held to a constant temperature of 800° C. to 1200° C. for a duration time of 10 minutes to 24 hours to form a white coating having a predetermined thickness. The substrate is more preferably held to a constant temperature of 950° C. to 1200° C. for a duration time of 10 minutes to 180 minutes, because this process can complete within a shorter time. The substrate is particularly preferably held to a constant temperature of 950° C. to 1100° C. for a duration time of 10 minutes to 120 minutes. For prevention of peeling of oxidation layer, the substrate after heating is preferably cooled at a rate of temperature drop of 2° C./min or less. In contrast, the rate of temperature rise in the heat treatment is not critical.

First Embodiment: Formation of Oxidation Layer on TNTZ1

Hot groove-rolled bars (10 mm in diameter) of a Ti-29Nb-13Ta-4.6Zr alloy (in mass percent) as a beta titanium alloy were held to 800° C. in a vacuum for one hour as a homogenization treatment, subjected to furnace cooling in argon gas, and cut to a thickness of 1 mm. For uniform surface quality, the works were subjected to dry grinding to a degree in terms of #1500 emery paper, degreased, and thereby had a clean surface. The works were then subjected to a surface oxidation in the air. Specifically, the works were held to a temperature of 950° C. to 1200° C. for one hour and then cooled; or held to 800° C. for 24 hours and then cooled; or held to 1000° C. for 10 to 180 minutes and then cooled. Cooling down to a temperature of 200° C. was controlled at a rate of temperature drop of 2.00° C./min, followed by furnace cooling.

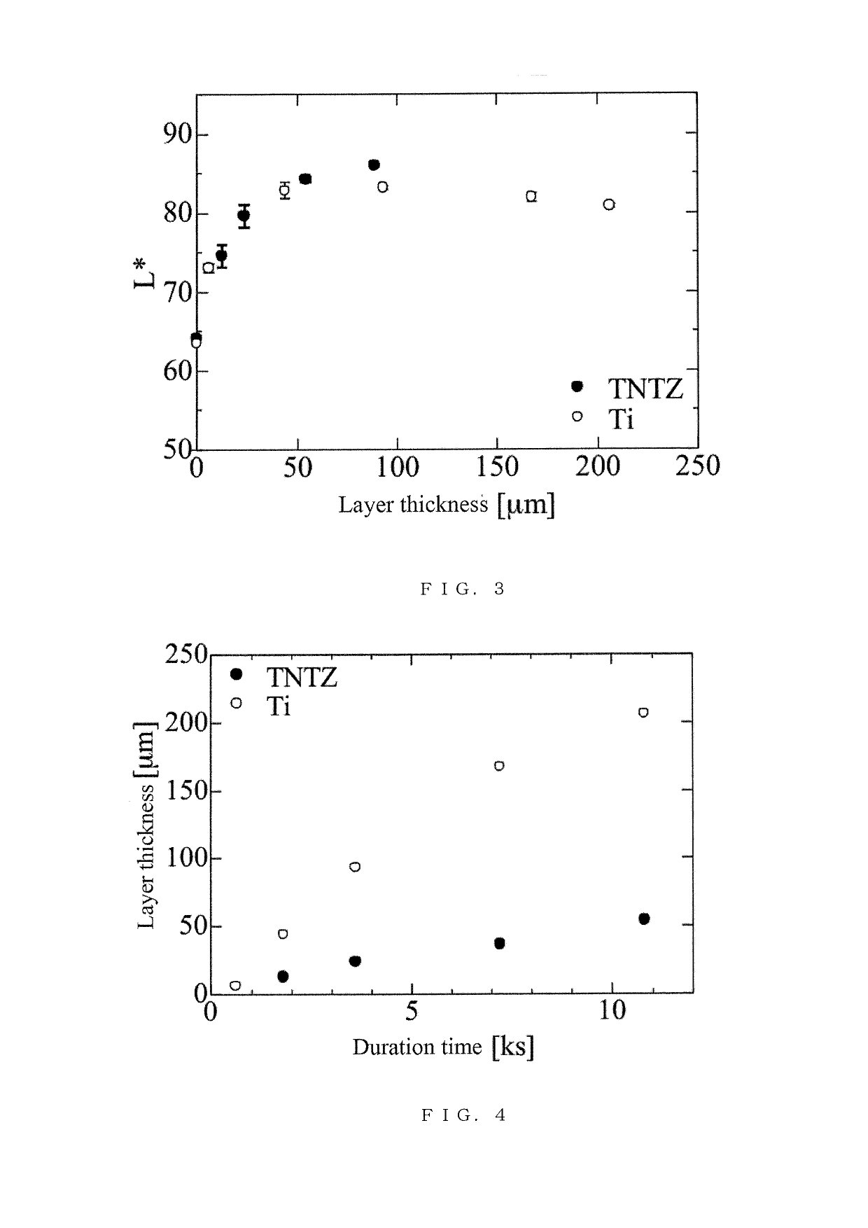

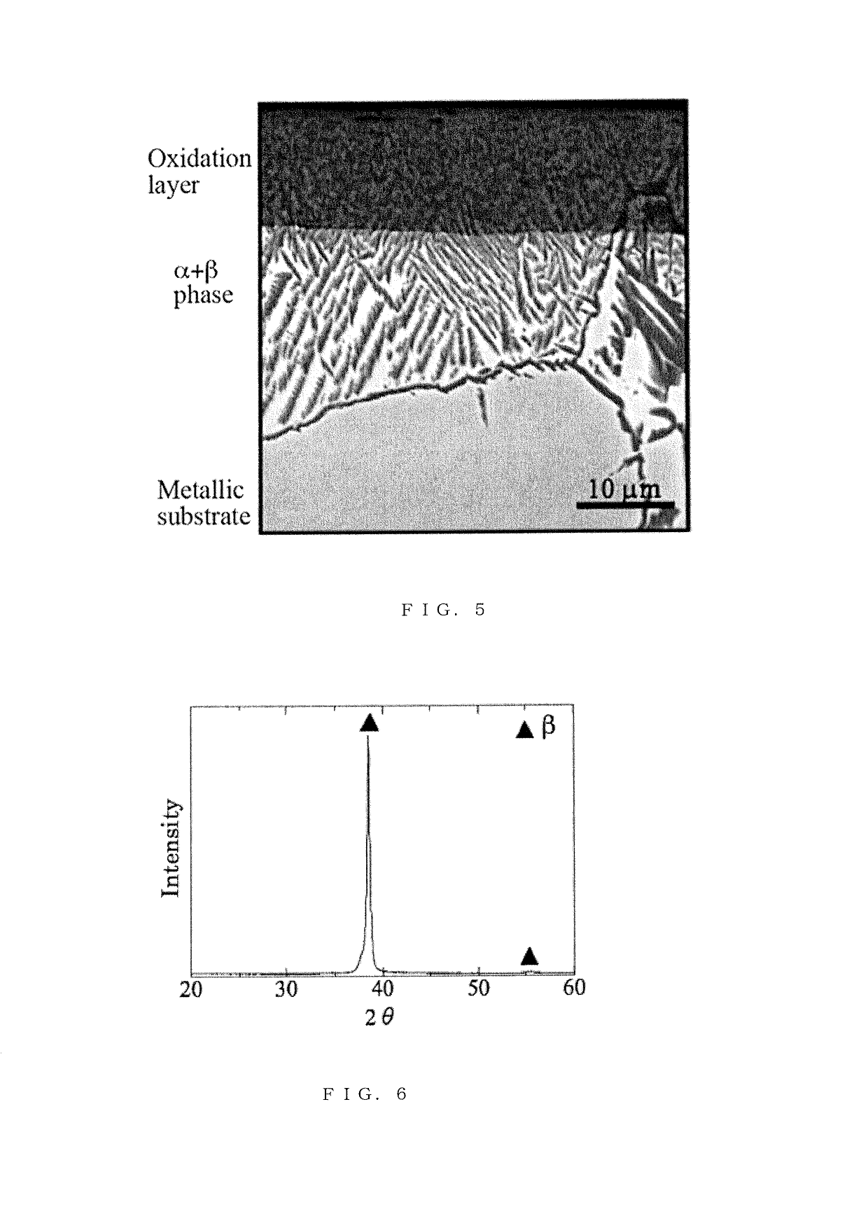

FIG. 2 depicts an illustrative formation of an oxidation layer, in which a Ti-29Nb-13Ta-4.6Zr alloy substrate was subjected to a heat treatment at a temperature of 1000° C. in the air for 30 minutes to form the oxidation layer. FIG. 2 demonstrates that a white coating was uniformly formed on a surface of the metallic substrate. FIG. 3 illustrates how the lightness L* of the coating varies depending on the coating layer thickness. The oxidation layer (coating) had an increasing lightness L* with an increasing layer thickness, where the lightness L* is indicated in terms of CIE L*a*b* color space. Specifically, the surface of the oxidation layer became brighter in color, and this composite material had a color changing from dark gray to white with an increasing whiteness . FIG. 4 demonstrates that the oxidation layer had an increasing thickness with an elongating duration time of heating (at a holding temperature of 1000° C.) . Specifically, the oxidation layer had an increasing lightness with an increasing layer thickness. FIG. 5 depicts a photograph of a cross section of the Ti-29Nb-13Ta-4.6Zr alloy substrate and a layer of oxide of the alloy, indicating that a dense oxidation layer was formed on a surface of the substrate, and an (α+β) phase containing a large amount of oxygen was formed between the substrate and the oxidation layer.

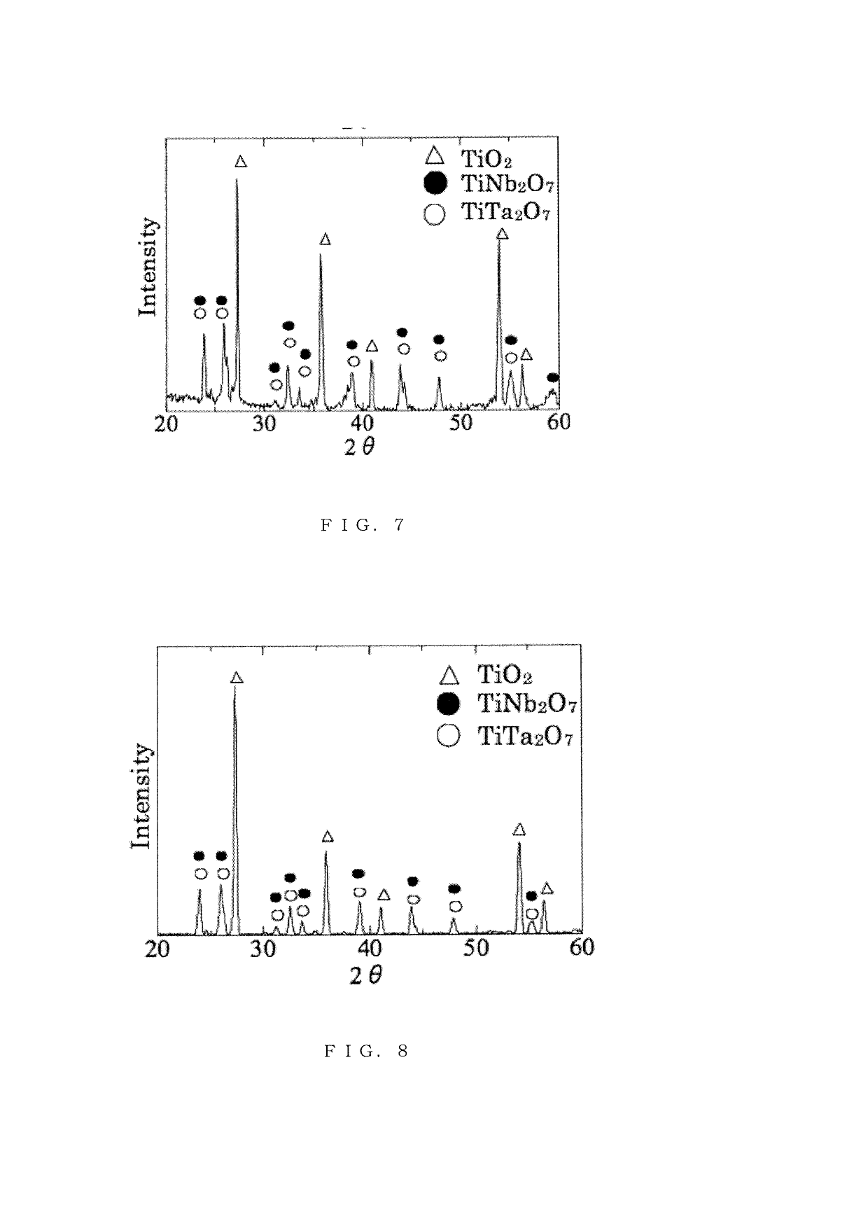

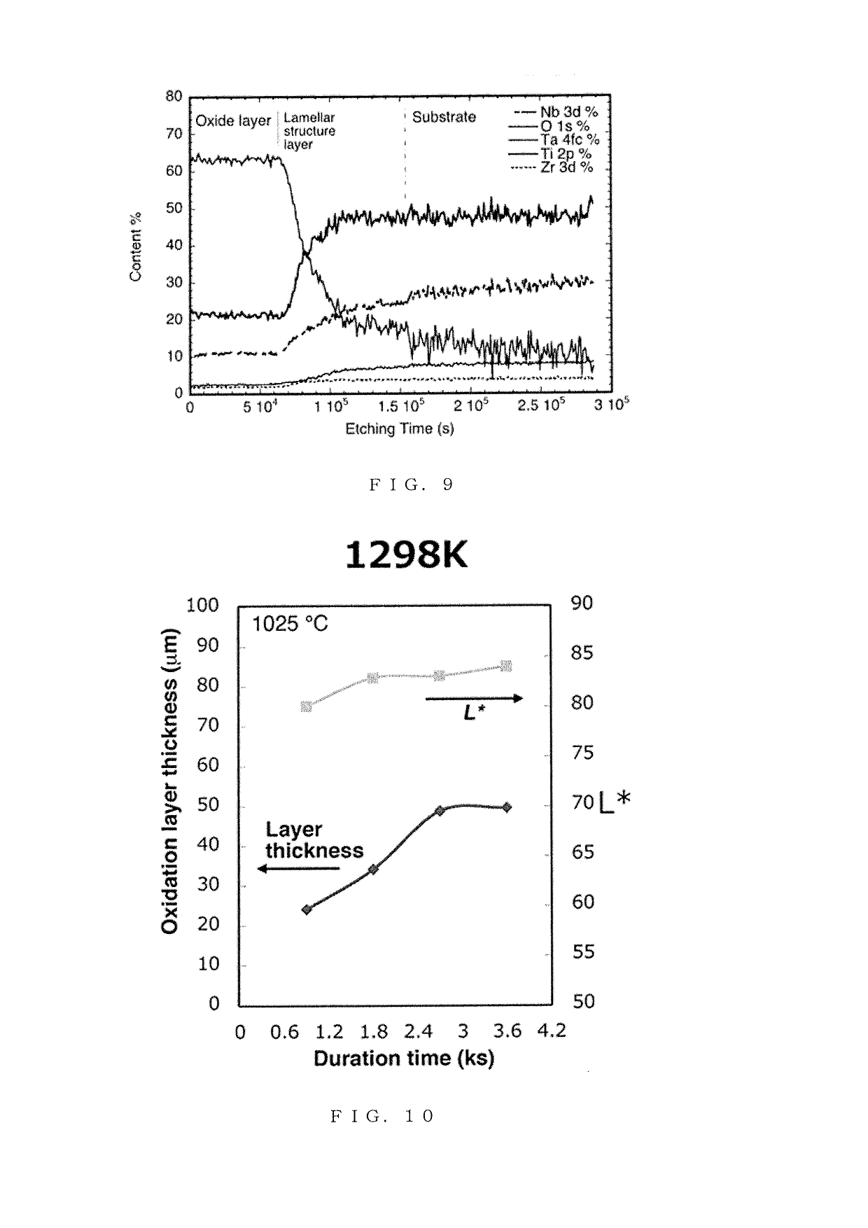

The Ti-29Nb-13Ta-4.6Zr alloy used as the substrate in this embodiment after solution treatment is a beta titanium alloy as indicated by the X-ray diffraction profile in FIG. 6, whereas the oxidation layer derived from the substrate mainly includes TiO₂, TiNb₂O₇, and TiTa₂O₇, as indicated in FIGS. 7 and 8.

The respective samples according to First Embodiment underwent a heat treatment at a temperature of 800° C. to 1200° C. in the air for a duration of 10 minutes to 24 hours and exhibited satisfactory adhesion without peeling of the oxidation layer from the substrate. The samples had whiteness in terms of lightness L* equal to or higher than those of natural teeth (L*=60 to 80).

A metal oxidation layer obtained according to First Embodiment was subjected to element analysis through X-ray photoelectron spectroscopy (XPS) in a depth direction with argon-etching. As a result, the oxidation layer was found to contain oxygen in a high content and to also contain titanium, niobium, tantalum, and zirconium. The contents of oxygen, titanium, niobium, and tantalum respectively gradually varied in the vicinity of the interface between the oxidation layer and the substrate, indicating a compositional gradient.

Second Embodiment: Formation of Oxidation Layer on TNTZ2 A Ti-36Nb-2Ta-3Zr alloy (in mass percent) as a beta titanium alloy was subjected to a homogenization treatment and a surface treatment by the procedure of First Embodiment, and then to a surface oxidation. The surface oxidation was performed by holding works to a temperature of 950° C. to 1200° C. in the air for one hour, followed by cooling, or holding the works to a temperature of 1000° C. in the air for 10 to 180 minutes, followed by cooling, in the same manner as in First Embodiment. Cooling down to a temperature of 200° C. was controlled at a rate of temperature drop of 2.00° C./min, followed by furnace cooling. Samples according to Second Embodiment underwent a heat treatment at a temperature of 950° C. to 1200° C. in the air for a duration of 20 minutes to 180 minutes and exhibited satisfactory adhesion without peeling of the oxidation layer from the substrate. The samples had whiteness in terms of lightness L* equal to or higher than those of natural teeth (L*=60 to 80) . FIG. 10 illustrates how the oxidation layer thickness and the lightness L* vary in samples which had been held at 1025° C. for 15 to 60 minutes and then cooled. The samples treated at this temperature had layer thicknesses of 20 to 50 μm and lightness L* of about 80 to about 85, which lightness is equal to or higher than those of natural teeth.

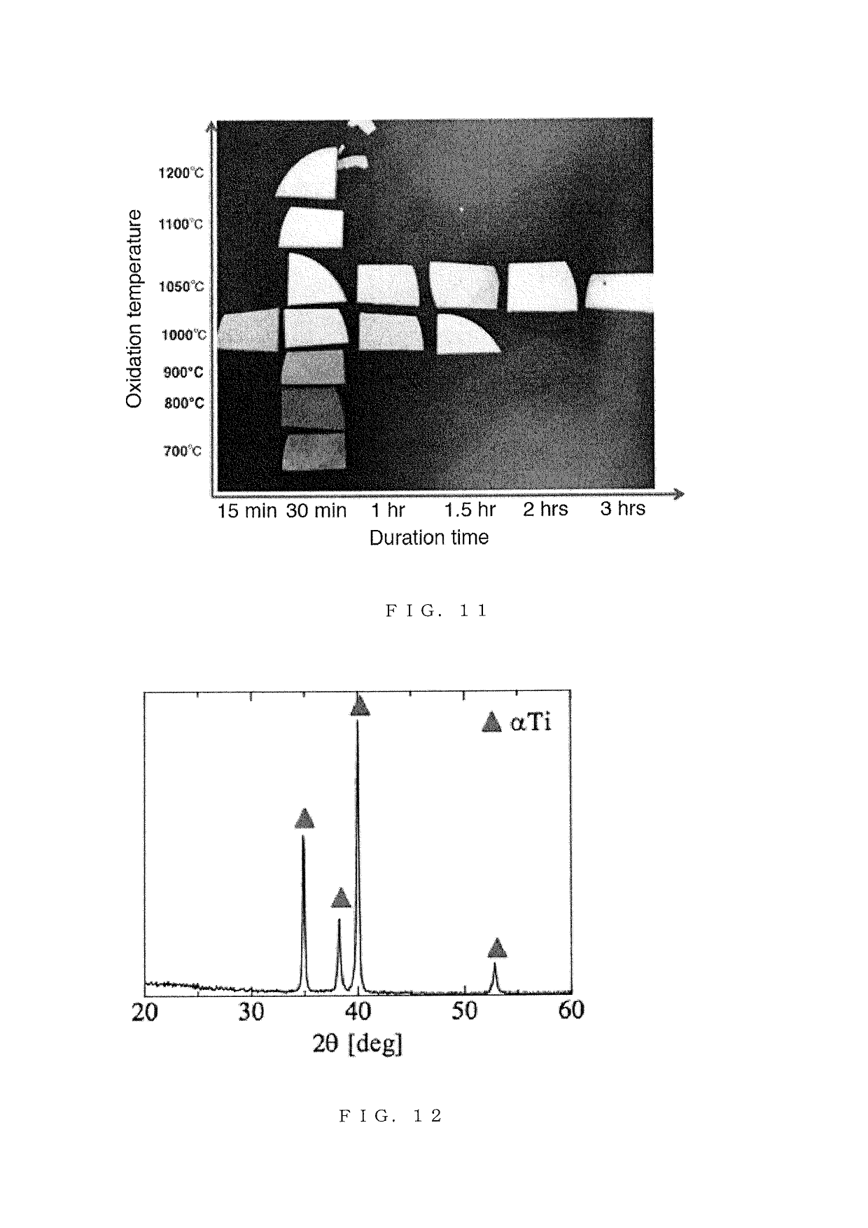

Third Embodiment: Formation of Oxidation Layer on CP Ti Bars (10 mm in diameter) of CP Ti (with a Ti content of 99.5 percent by mass or more) as an alpha titanium alloy were held to 800° C. in a vacuum for 5 minutes as a homogenization treatment, cooled in argon gas, and cut to a thickness of 1 mm. For uniform surface quality, the samples were subjected to dry grinding to a degree in terms of #1500 emery paper, degreased, and thereby had a clean surface. The samples were then subjected to surface oxidation of holding to different temperatures in the air for different duration times to give oxidation layers. The results are indicated in FIG. 11. The resulting samples had lightness L* of up to 90 or more, equal to or higher than those of natural teeth (L*=60 to 80).

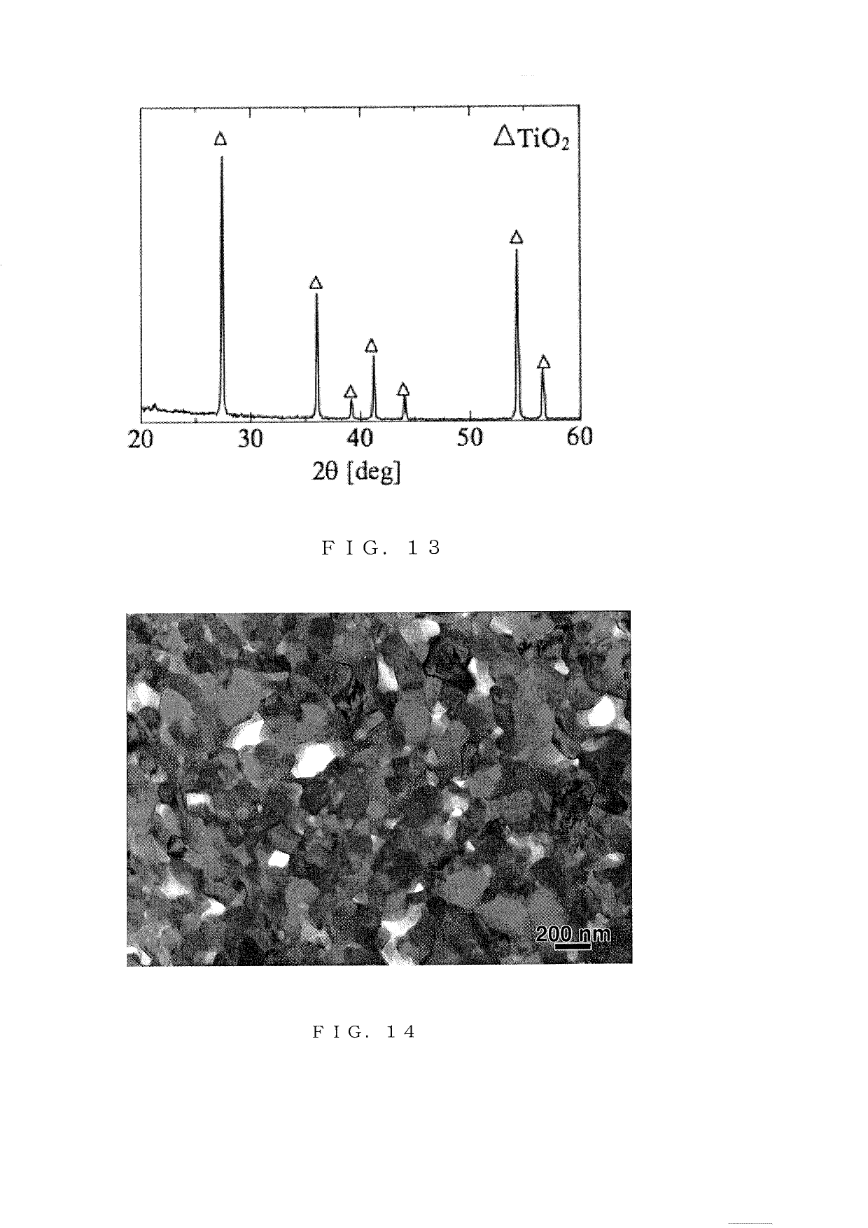

As is demonstrated by FIG. 11, white oxidation layers can be formed on a titanium surface also by subjecting CP Ti to heat treatments in the air at different temperatures for different duration times. A CP Ti substrate having an alpha phase crystal structure as indicated in FIG. 12, when subjected to a heat treatment in the same manner as above, gave TiO₂ as indicated in FIG. 13.

Evaluation of Oxidation Layer

The oxidation layers each formed on the Ti-29Nb-13Ta-4. 6Zr alloy substrate (substrate thickness: 0.95 mm; oxidation layer thickness: 0.035 mm) according to First Embodiment were examined on hardness measurement using a nanoindenter and on adhesion with the substrate. The oxidation layers had a hardness in terms of Vickers hardness Hv of about 500 MPa and a peel strength of 14 to 70 MPa, evaluated as practically fine. Peeling occurred at the interface between the metallic substrate and the oxidation layer or inside the oxidation layer. The oxidation layers of the Ti-29Nb-13Ta-4.6Zr alloy according to First Embodiment had small grain sizes of 100 to 500 nm, demonstrating that the layers had a dense crystal structure suitable for use in dental materials. FIG. 14 depicts a transmission electron photomicrograph of an oxidation layer according to First Embodiment. In contrast, the oxidation layers of CP Ti according to Third Embodiment had somewhat large grain sizes of 0.5 to 2 μm and each had a layered crystal structure.

while the above description is of the preferred embodiments of the present invention, it should be appreciated that the invention may be modified, altered, varied without deviating from the scope and fair meaning of the following claims.

What is claimed is:

1. A metal-metal oxide composite material for dental prosthesis, comprising:
a metallic substrate comprising titanium or a titanium alloy; and
a metal oxidation layer present on a surface of the substrate, the metal oxidation layer being an oxide of the substrate metal .

2. The metal-metal oxide composite material of claim 1, wherein the titanium alloy comprises:
30 to 70 percent by mass of titanium (Ti);
20 to 50 percent by mass of niobium (Nb);
1 to 30 percent by mass of tantalum (Ta); and
1 to 15 percent by mass of zirconium (Zr).

3. The metal-metal oxide composite material of claim 1, as a crown material.

4. The metal-metal oxide composite material of claim 1, wherein the metal oxidation layer has a thickness of 10 μm or more, and wherein a ratio of the thickness of the metal oxidation layer to the total thickness of the metallic substrate and the metal oxidation layer is 30% or less.

5. A method for manufacturing the metal-metal oxide composite material of claim 1, the method comprising the step of:
performing a heat treatment of titanium or a titanium alloy as a substrate at a high temperature to oxidize a surface of the substrate to thereby form a coating with a high whiteness on the substrate.

6. The method of claim 5, wherein the heat treatment of the titanium or titanium alloy substrate is performed at a temperature of 800° C. to 1200° C. in an oxygen-containing atmosphere for a time of 10 minutes to 24 hours.

7. The method of claim 6, wherein the heat treatment is performed by holding the substrate to a constant temperature of 950° C. to 1100° C. for a duration time of 10 to 120 minutes.

8. The method of claim 6, further comprising the step of cooling the substrate and the coating at a rate of temperature drop of 2° C./min or less after the heat treatment.
